(19) United States
(12) Patent Application Publication
(10) Pub. No.: US 2003/0174702 A1
(43) Pub. Date: Sep. 18, 2003

(54) Modifying overhead data of a transport layer frame

(76) Inventors: Michael Meier, Braunschweig (DE); Michael Kauschke, Braunschweig (DE)

Correspondence Address: FISH & RICHARDSON, PC, 4350 LA JOLLA VILLAGE DRIVE, SUITE 500, SAN DIEGO, CA, 92122, US

(21) Appl. No.: 10/099,896

(22) Filed: Mar. 14, 2002

(51) Int. Cl. H04L 12/28

(52) U.S. Cl. 370/392

(57) ABSTRACT

A network device may extract overhead data from a frame and send the extracted overhead data to an external programmable device. The programmable device may modify the extracted overhead data. Upon receiving the modified overhead data, the network device can insert it into said frame.

### BACKGROUND

This disclosure relates to modifying overhead data of a transport layer frame.

Within networks, different layers of transport hierarchies are defined. The transport layer is used to organize data into frames. These frames may be transmitted in a data stream. Frames comprise overhead data and payload data. The overhead data typically includes the start of frame information and may contain other administrative information as well. The payload data includes the actual voice or telephone data or other digital data such as Internet packets.

Occasionally, the overhead data of transport layer frames within a network may be modified to adapt to a change in the current network status.

### BRIEF DESCRIPTION OF DRAWINGS

FIG. 1 illustrates a system that includes network devices that can modify the overhead data of a transport layer frame.

FIG. 2 illustrates a data frame.

FIG. 3 is a diagram for the data streams.

FIG. 4 is a timing diagram for the overhead data modification.

FIG. 5 illustrates modification of the overhead data of a transport layer frame.

### DETAILED DESCRIPTION

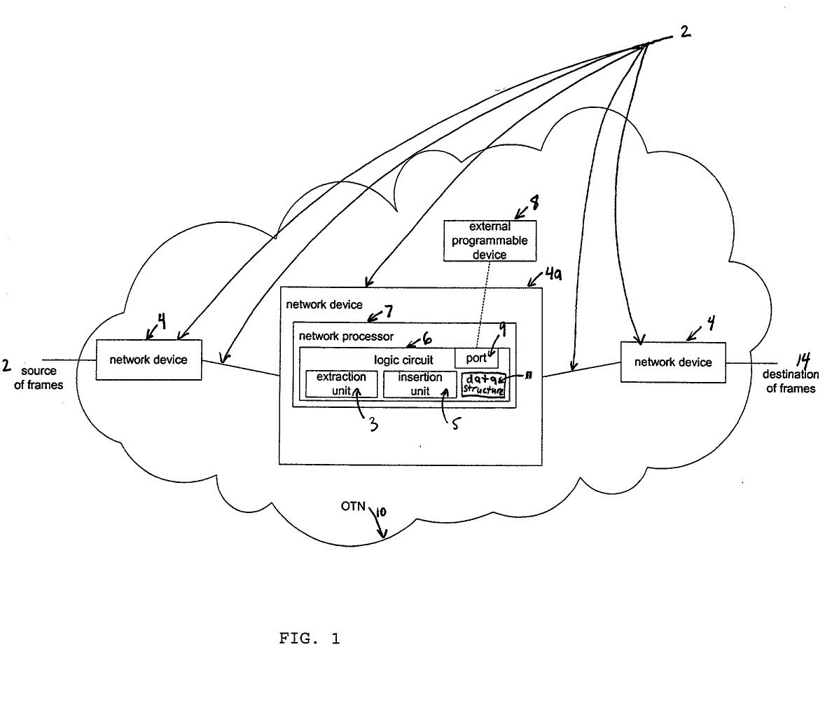

Referring to FIG. 1, a network system may include one or more network nodes 2 that include a source of frames 12, a destination of frames 14 and one or more network devices 4, 4a such as electrical devices, coupled to a network, for example, an optical transport network (OTN) 10. The communication protocol used by the devices in the OTN system may be, for example, as defined by ITU-T G.709 or ITU-T G.707. The present techniques may be incorporated, for example, into the Intel® IXF30005 and IXF30007 optical digital wrapper processors to transmit integrated multi-protocol data through fiber optic cables. These devices can generate ITU-T G.709 frames from SONET/synchronized digitized hierarchy (SDH) frames or vice versa. These devices also may be capable of enhanced forward error correction (FEC) to help reduce errors in data transmission. Each network device, such as the device 4a, includes a network processor 7 with a logic circuit 6 to interface with an external programmable device 8, such as a field-programmable gate array device (FPGA) or digital signal processor (DSP). The external programmable device 8 may be coupled to the logic circuit 6 through a port 9. The network processor may include a data structure 11.

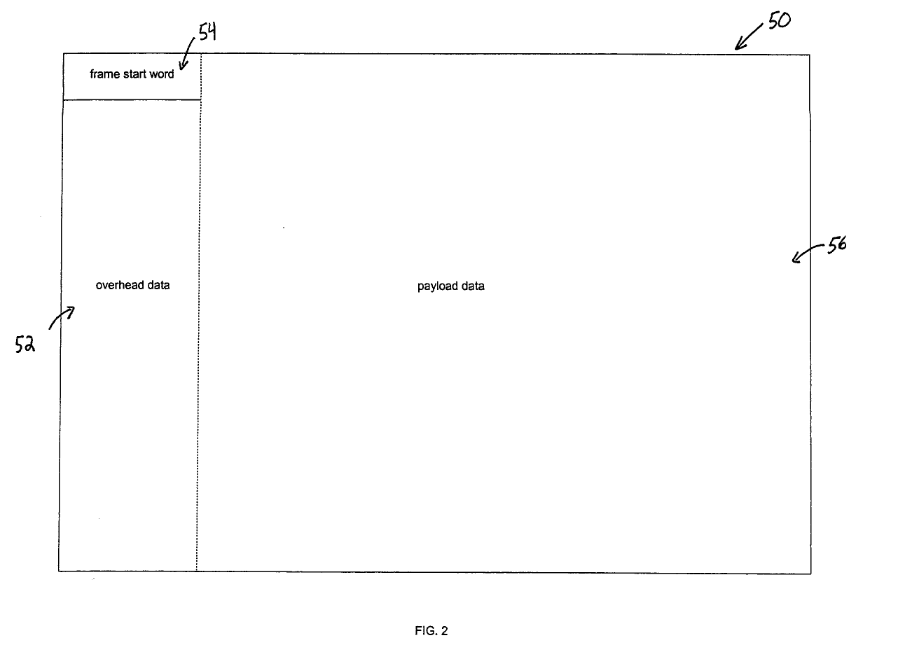

The data transmitted and received by the network nodes in the network system is organized into frames by the transport layer. Referring to FIG. 2, each frame 50 comprises payload data 56 and overhead data 52. The payload data may include the actual voice or telephone data that is in the frame or other digital data such as Internet packets. The overhead data may include start of frame information 54 as well as other administrative information.

The network node 2 receives an incoming data stream of frames, each of which includes overhead and payload portions. The overhead data portion (e.g., the administrative information) of a frame may be modified to handle a change in network state. The administrative information may include information of the network topology. Modification of the overhead data portion of a frame may be performed in real-time with zero-latency based on the incoming overhead data of that frame by one or more network devices in a single node. Network devices comprising the network node may find the start of a frame by searching for the frame start word 54 (FIG. 2). A network device can extract information from the overhead data portion of a frame or may insert information into the overhead data portion of a frame. Such information may be generated and analyzed by software or by hardware. For example, software may be used to generate a trace identifier to identify the source or destination of the data stream. Similarly, hardware may be used to generate parity information.

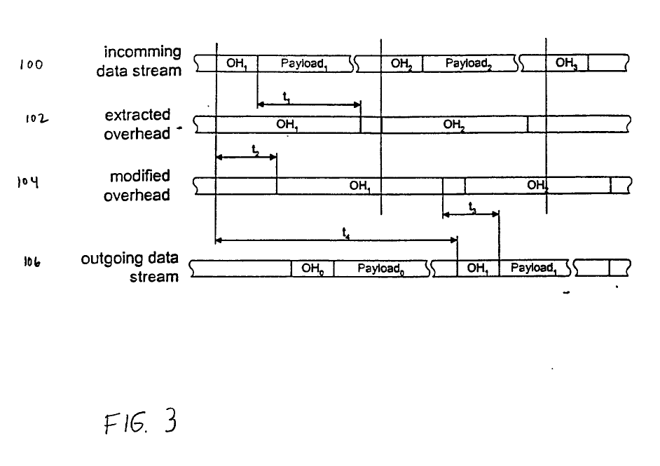

In one implementation, the logic circuit 6 is implemented in the network processor 7. The logic circuit includes an extraction unit 3 that is responsible for extracting the overhead information from a frame and an insertion unit 5 that is responsible for inserting the modified information into a frame. Referring to FIG. 3, as the network node receives each frame in the incoming data stream 100, which includes a continuous flow of overhead data and payload data, the overhead data portion of each frame is separated from the payload data of the frame 102.

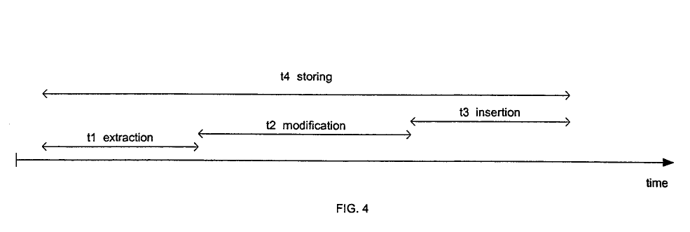

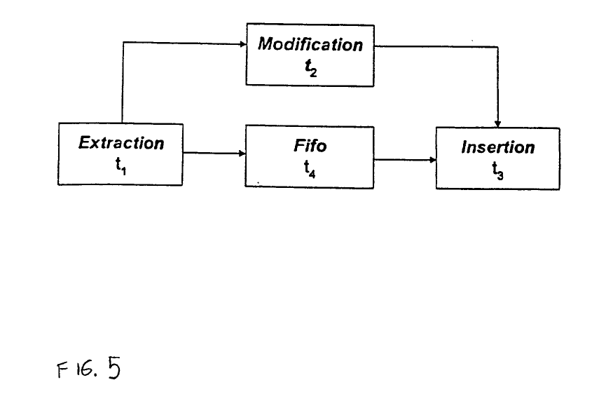

Referring to FIGS. 3-5, during time t1, the logic circuit 6 of one of the network devices in the network node, such as device 4a, extracts the overhead data portion from an incoming frame. The logic circuit 6 sends the extracted overhead data 102 to the external programmable device 8 for processing through the port 9. The external programmable device 8 receives the extracted overhead data from the logic circuit. The payload portion of the frame may be processed by the network processor 7. To reduce the number of pins at the logic circuit 6 and external programmable device 8 and to make the interface simpler, the overhead data may be transferred between the logic circuit and the external programmable device while the network processor is processing the payload data.

During time t2, the external programmable device may modify the overhead data portion of the frame. The extracted overhead data may be replaced entirely with new overhead data or only some bits or bytes of the overhead data may be modified. Therefore, at least some bits of the extracted overhead data may be modified. In some cases, the external programmable device may leave the overhead data portion of the frame unmodified. After a frame has been modified, the external programmable device sends the modified overhead data 104 to the logic circuit.

The insertion unit 5 of the logic circuit 6 measures the amount of time needed to send the extracted overhead data to the external programmable device, the amount of time needed by the external programmable device for modification of the overhead data and the amount of time needed to receive the modified overhead data from the external programmable device. The logic circuit uses this information to artificially delay the payload data by storing at least a portion of the frame, whose overhead data has been extracted, for example, in a first-in, first-out (FIFO) data structure 11. Because at most only one frame is stored in the FIFO at a time, the likelihood of inserting information into the wrong frame may be reduced. The amount of time payload data of the frame is stored is based upon a time to send the extracted overhead data to the external programmable device, modify the overhead data, and receive the modified overhead data from the external programmable device. During time t3, the modified overhead data is inserted into an outgoing frame corresponding to the frame from which the overhead data was extracted. The outgoing data stream 106 includes the outgoing frame.

In the illustrated implementation, the times to extract the overhead data from a frame (t1), modify the overhead data (t2), and insert the modified overhead data into a frame (t3) are related by the following equation:

t4≅t1+t2+t3.

The amount of time (t4) payload data of the frame is stored approximately equals the total amount of time spent extracting, modifying and inserting the overhead data. At least one of the times for extracting, storing, modifying and inserting may be adjusted. The processing described above may be performed in a pipelined manner.

The present technique may provide the advantage of a very fast reaction to the latest information about the network environment. The technique may prevent the hardware of the network devices from becoming unusable when a network state changes. The technique also may provide greater flexibility in modifying overhead data with an external programmable device. For example, the system initially may be configured to process frames of a first network state. By reprogramming the external programmable device, the system then could process frames of the new network state. A technique of changing the overhead data by extracting the overhead data of a frame, sending the extracted overhead data to an external programmable device, modifying the overhead data in the external programmable device, receiving modified overhead data from the external programmable device, and inserting the modified overhead data for another frame and further including modifying extracted overhead data of the one frame according to a network state different from a network state used to modify the extracted overhead data of the other frame may be used.

The present technique also allows the extraction unit 3 and the insertion unit 5 to be implemented in the same logic circuit 6. This saves space on the network processor and reduces the number of components used.

Various features of the system can be implemented in hardware, software, or a combination of hardware and software. For example, a processor that stores instructions that cause the processor to perform the functions of the logic circuit of the present technique may replace the logic circuit. Furthermore, some aspects of the system can be implemented in computer programs executing on programmable computers. Each program can be implemented in a high level procedural or object-oriented programming language to communicate with a computer system. Furthermore, each such computer program can be stored on a storage medium, such as read-only-memory (ROM) readable by a general or special purpose programmable computer, for configuring and operating the computer when the storage medium is read by the computer to perform the functions described above.

Other implementations are within the scope of the following claims.

What is claimed is:

1. A method comprising:
extracting overhead data from a frame;
sending the extracted overhead data to an external programmable device;
modifying the extracted overhead data of the frame in the programmable device;
receiving the modified overhead data from the external programmable device; and
inserting the modified overhead data into said frame.

2. The method of claim 1 wherein said modifying includes modifying at least some bits of the extracted overhead data.

3. The method of claim 1 further comprising storing payload data of the frame in a data structure for an amount of time based upon a time to send the extracted overhead data to the external programmable device, modify the overhead data, and receive the modified overhead data from the external programmable device.

4. The method of claim 3 including performing said extracting, storing, modifying and inserting in a pipelined manner.

5. The method of claim 3 comprising performing said extracting, sending, modifying, receiving, and inserting for another frame and including modifying extracted overhead data of the one frame according to a network state different from a network state used to modify the extracted overhead data of the other frame.

6. The method of claim 3 wherein the amount of time payload data of the frame is stored in a data structure is approximately equal to the total amount of time spent extracting, modifying and inserting the overhead data.

7. The method of claim 6 including adjusting at least one of the times for extracting, storing, modifying and inserting.

8. An apparatus comprising:
a network processor to process payload data of a frame;
a logic circuit coupled to the network processor, the logic circuit configured to:
extract overhead data from the frame;
send the extracted overhead data to an external programmable device;
receive modified overhead data from the external programmable device; and
insert the modified overhead data into said frame.

9. The apparatus of claim 8 further comprising an external programmable device, the external programmable device programmed to:
receive the extracted overhead data from the logic circuit;
modify the extracted overhead data; and
send the modified overhead data to the logic circuit.

10. The apparatus of claim 8 wherein the programmable device comprises a field-programmable gate array.

11. The apparatus of claim 8 including a data structure in the logic circuit, wherein the logic circuit is further configured to store payload data of the frame in the data structure for an amount of time based upon a time to send the extracted overhead data to the external programmable device, modify the overhead data, and receive the modified overhead data from the external programmable device.

12. The apparatus of claim 8 wherein the logic circuit is further configured to store payload data of the frame in a data structure for an amount of time based upon a time to send the extracted overhead data to the external programmable device, modify the overhead data, and receive the modified overhead data from the external programmable device.

13. The apparatus of claim 12 wherein the data structure comprises a first-in, first-out data structure.

14. The apparatus of claim 12 wherein the amount of time payload data of the frame is stored in a data structure is approximately equal to the total amount of time spent extracting, modifying and inserting the overhead data.

15. The apparatus of claim 14 including adjusting at least one of the times for extracting, storing, modifying and inserting.

16. An apparatus comprising:
a network processor to process payload data of a frame;
a logic circuit coupled to the network processor, the logic circuit configured to:
extract overhead data from the frame;
send the extracted overhead data to an external programmable device;
receive modified overhead data from the external programmable device; and
insert the modified overhead data into said frame; and
an external programmable device coupled to the logic circuit, the external programmable device programmed to:
receive the extracted overhead data from the logic circuit;
modify the extracted overhead data; and
send the modified overhead data to the logic circuit.

17. The apparatus of claim 16 wherein the logic circuit is further configured to store payload data of the frame in a data structure for an amount of time based upon a time to send the extracted overhead data to the external programmable device, modify the overhead data, and receive the modified overhead data from the external programmable device.

18. The apparatus of claim 17 wherein the amount of time payload data of the frame is stored in a data structure is approximately equal to the total amount of time spent extracting, modifying and inserting the overhead data.

19. The apparatus of claim 18 including adjusting at least one of the times for extracting, storing, modifying and inserting.

20. An apparatus comprising:
a network device comprising:
a network processor, the network processor storing instructions that when applied to the processor cause the processor to:
extract overhead data from a frame;
send the extracted overhead data to an external programmable device;
process payload data of the frame;
receive modified overhead data from the external programmable device; and
insert the modified overhead data into said frame; and
an external programmable device coupled to the network processor, the external programmable device programmed to:
receive the extracted overhead data from the logic circuit;
modify the extracted overhead data; and
send the modified overhead data to the logic circuit.

21. The apparatus of claim 20 wherein the network processor is further configured to store payload data of the frame in a data structure for an amount of time based upon a time to send the extracted overhead data to the external programmable device, modify the overhead data, and receive the modified overhead data from the external programmable device.

22. The apparatus of claim 21 wherein the amount of time payload data of the frame is stored in a data structure is approximately equal to the total amount of time spent extracting, modifying and inserting the overhead data.

23. The apparatus of claim 22 including adjusting at least one of the times for extracting, storing, modifying and inserting.

24. A system comprising:
a source of data frames;
a destination for the data frames;
an external programmable device;
a network device to transfer the data frames from the source to the destination, the network device comprising:
a network processor to process payload data of a frame;
a logic circuit coupled to the network processor, the logic circuit configured to:
extract overhead data from the frame;
send the extracted overhead data to an external programmable device;
receive modified overhead data from the external programmable device; and
insert the modified overhead data into said frame; and
an external programmable device coupled to the logic circuit, the external programmable device programmed to:
receive the extracted overhead data from the logic circuit;
modify the extracted overhead data; and
send the modified overhead data to the logic circuit.

25. The system of claim 24 wherein the logic circuit is further configured to store payload data of the frame in a data structure for an amount of time based upon a time to send the extracted overhead data to the external programmable device, modify the overhead data, and receive the modified overhead data from the external programmable device.

26. The system of claim 24 wherein the amount of time payload data of the frame is stored in a data structure is approximately equal to the total amount of time spent extracting, modifying and inserting the overhead data.

27. The system of claim 26 including adjusting at least one of the times for extracting, storing, modifying and inserting.

28. An article comprising a computer-readable medium including computer-readable instructions that, when applied to a computer system, cause the computer system to:
extract overhead data from a frame;
send the extracted overhead data to an external programmable device; and
in response to receiving modified overhead data from the external programmable device, insert the modified overhead data into said frame.

29. The article of claim 28 further storing instructions that, when applied to a computer system, cause the computer system to:
store payload data of the frame in a data structure for an amount of time based upon a time to send the extracted overhead data to the external programmable device, modify the overhead data in an external programmable device, and receive the modified overhead data from the external programmable device.

30. The article of claim 28 including adjusting at least one of the times for extracting, storing, modifying and inserting wherein the amount of time the payload data of the frame is stored in a data structure is approximately equal to the total amount of time spent extracting, modifying and inserting the overhead data.
